(19) United States
(12) Patent Application Publication
(10) Pub. No.: US 2025/0249518 A1
(43) Pub. Date: Aug. 7, 2025

(54) TRIMMING DEVICE OF EDGE BANDING MACHINE

(71) Applicant: OAV EQUIPMENT AND TOOLS, INC., TAICHUNG CITY (TW)

(72) Inventor: YEN-TSUNG CHANG, TAICHUNG CITY (TW)

(21) Appl. No.: 18/756,896

(22) Filed: Jun. 27, 2024

(30) Foreign Application Priority Data
Feb. 5, 2024 (TW) 113104508

(51) Int. Cl. B23C 3/12

(52) U.S. Cl. CPC B23C 3/126; B23C 2270/20

(57) ABSTRACT

A trimming device of the edge banding machine includes a mounting assembly attached to a fixing assembly, a wheel assembly mounted to the mounting assembly and having a first wheel rolled on a top surface of a to-be-processed workpiece and a second wheel rolled on an edge band adhered to a lateral side of the to-be-processed workpiece, a moving scraper unit including a feeding and retracting assembly having a slider slidably mounted on a slide groove of the mounting assembly, and a scraper assembly mounted on the feeding and retracting assembly and having a scraper, and a retractable rod driving the moving scraper unit to move along the slide groove. Through movement of the moving scraper unit and action of the retractable rod, the scraper maintains constant contact with the edge band to solve a problem of over-trimming or instability of the front and rear ends of the edge band.

### BACKGROUND OF THE INVENTION

### 1. Field of the Invention

The present invention relates to edge banding machines and more particularly, to a trimming device of an edge banding machine.

### 2. Description of the Related Art

In the back-end process of an edge banding for a wood board, the upper and lower trimming devices are used to chamfer the edge band. The traditional design is a swing type design, such as Taiwan Patent No. 1796184, which uses a single spindle to rotate the entire mechanism. Although the structure is relatively simple, it often leads to over-trimming or instability at the front and rear ends of the edge band after edge banding. As such, there is still room for improvement.

### SUMMARY OF THE INVENTION

It is one objective of the present invention to provide a trimming device of an edge banding machine, which improves stability of trimming an edge band after edge banding.

To attain the above objective, the trimming device of the edge banding machine comprises a fixing assembly, a mounting assembly attached to the fixing assembly and having a slide groove, a first wheel assembly mounted to the mounting assembly and having a first wheel for rolling on a top surface of a to-be-processed workpiece, a second wheel assembly mounted to the mounting assembly and having a second wheel for rolling on an edge band adhered to a lateral side of the to-be-processed workpiece, a moving scraper unit including a feeding and retracting assembly having a slider slidably mounted on the slide groove of the mounting assembly, and a scraper assembly mounted on the feeding and retracting assembly and having a scraper, and a retractable assembly having a retractable rod driving the moving scraper unit to move along the slide groove of the mounting assembly.

It can be seen from the above that through straight forward and backward movement of the moving scraper unit and action of the retractable rod, the scraper is allowed to maintain constant contact with the edge band to improve stability of trimming the edge band after edge banding, thereby achieving the purpose of the present invention.

Preferably, the fixing assembly includes a main body, a floating member movable relative to the main body via a plurality of linear bearings, and a spring urging the floating member downwards. The mounting assembly is connected to the floating member.

Preferably, the spring is sleeved on an upright pole of the fixing assembly and abutted against the floating member.

Preferably, the moving scraper unit further includes a forward stop member abutted against a forward stop portion of the mounting assembly when the moving scraper unit is moved forwards.

Preferably, the scraper assembly has a backward stop block abutted against a backward stop portion of the mounting assembly when the moving scraper unit is moved backwards.

Preferably, the feeding and retracting assembly has a first pivot member pivotally mounted to the scraper assembly.

Preferably, the feeding and retracting assembly has two adjusting edges abutted by two adjusting screws provided by the scraper assembly, respectively.

Preferably, the scraper assembly has an upper block located above the slider, two lateral blocks attached to the upper block and located on two sides of the slider, and a lower block attached to the lateral blocks and located below the slider and mounted with the scraper.

Preferably, the retractable assembly is connected to the feeding and retracting assembly for driving the feeding and retracting assembly.

Preferably, the retractable assembly is connected to the scraper assembly for driving the scraper assembly.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a front and top perspective view of a trimming device of the present invention.

FIG. 2 is a front view of FIG. 1.

FIG. 3 is a rear and bottom perspective view of the trimming device of the present invention.

FIG. 4 is a front view of FIG. 3.

FIG. 5 is an exploded view of the trimming device of the present invention.

FIG. 6 is an exploded view of the trimming device of the present invention from another perspective.

FIG. 7 is a perspective view of the mounting assembly, the first wheel assembly, and the second wheel assembly provided by the trimming device of the present invention.

FIG. 8 is a front view of the moving scraper unit and the retractable assembly provided by the trimming device of the present invention.

FIG. 9 is a sectional view taken along line 9-9 of FIG. 8.

FIG. 10 is a sectional view taken along line 10-10 of FIG. 8.

FIG. 11 is a rear view of the moving scraper unit and the retractable assembly provided by the trimming device of the present invention.

FIG. 12 is a sectional view taken along line 12-12 of FIG. 11.

FIG. 13 is a sectional view taken along line 13-13 of FIG. 11.

FIG. 14 is a perspective view of the scraper assembly provided by the trimming device of the present invention.

FIG. 15 is a perspective view of the scraper assembly provided by the trimming device of the present invention from another perspective.

### DETAILED DESCRIPTION OF THE INVENTION

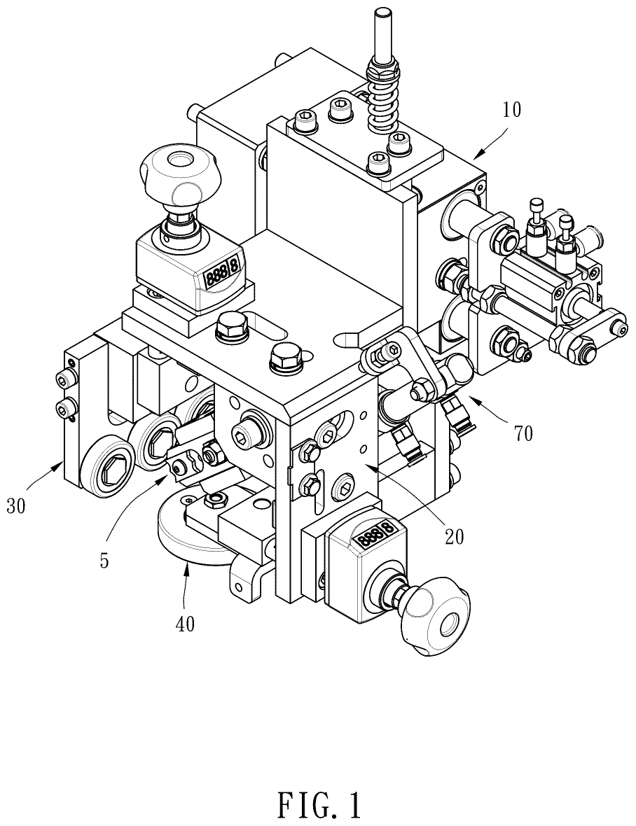

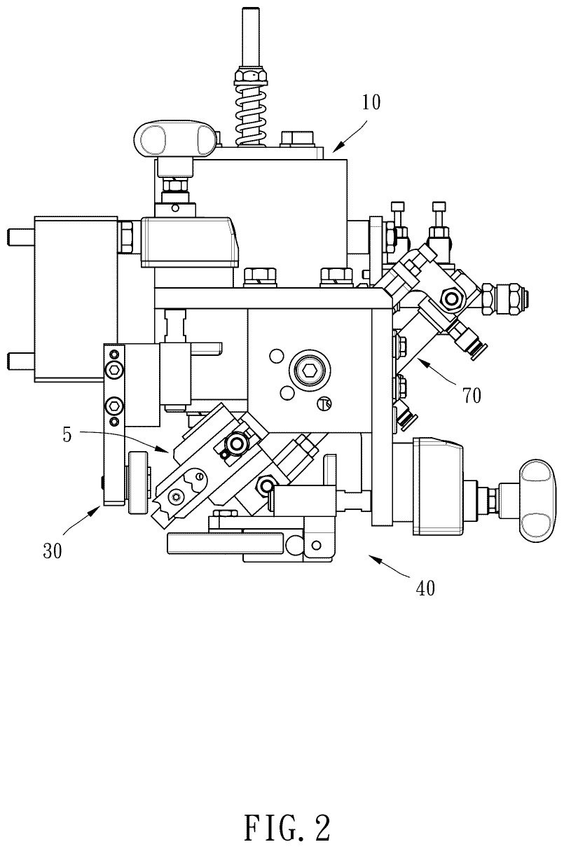

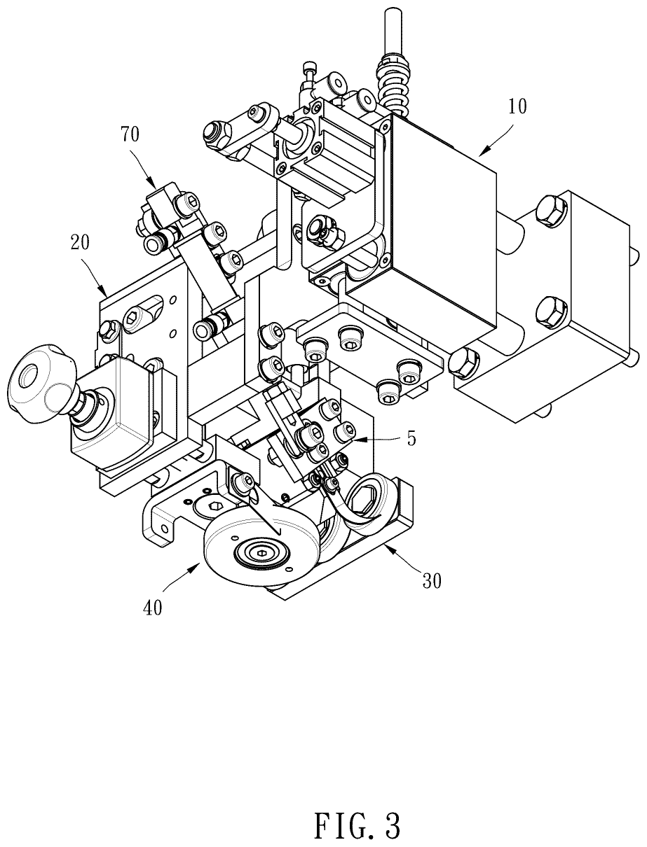

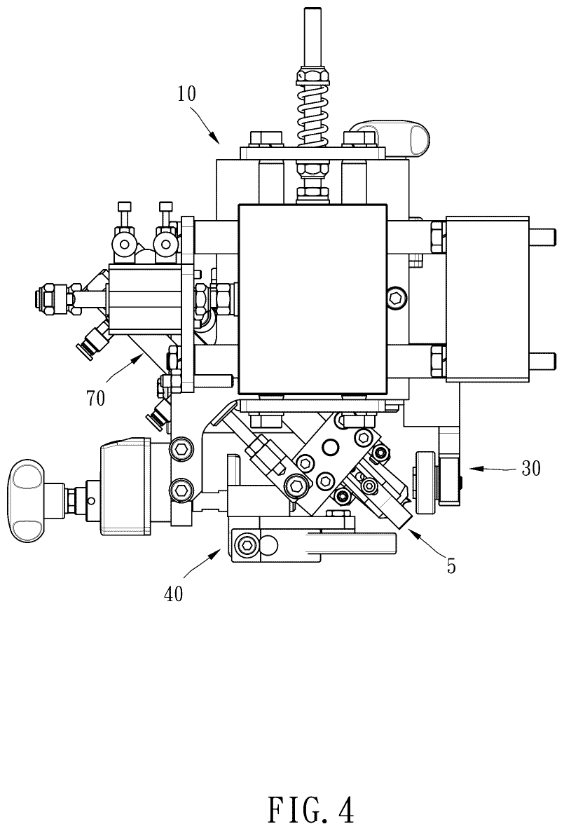

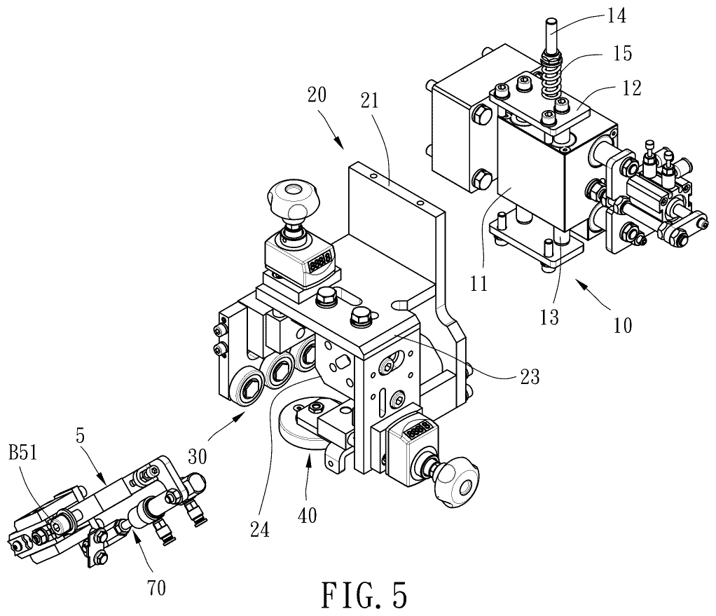

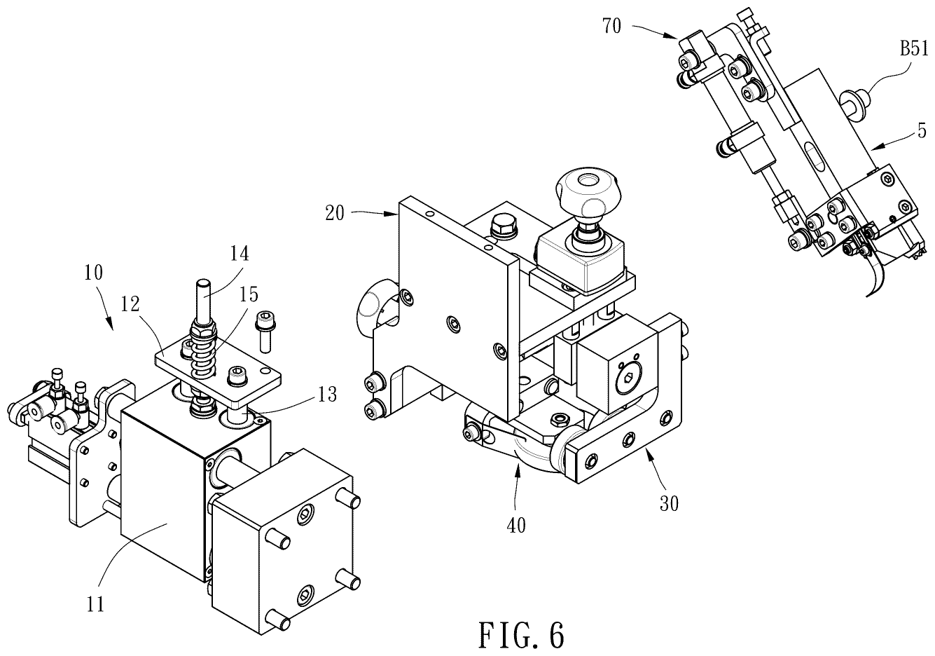

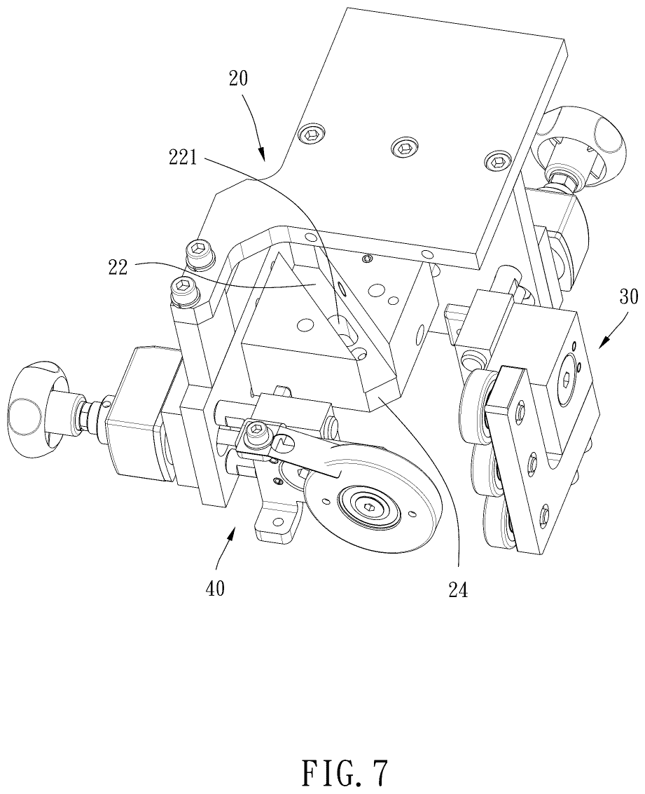

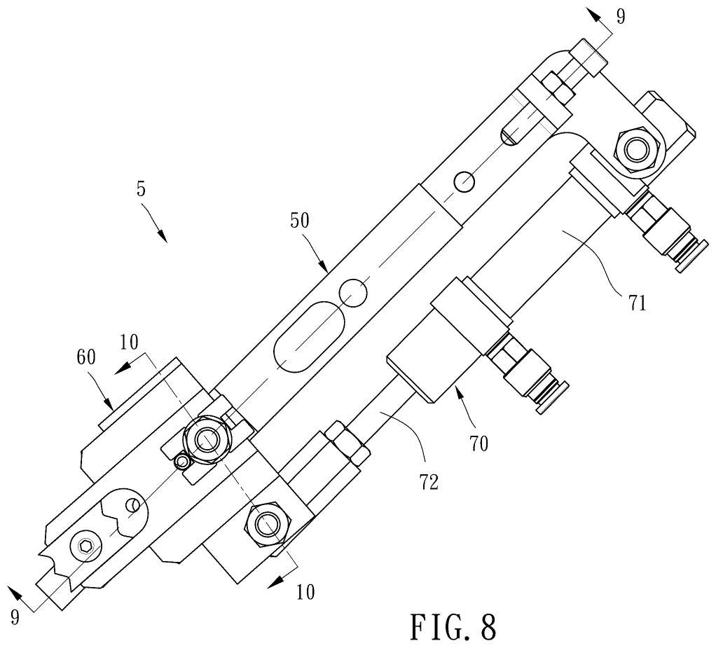

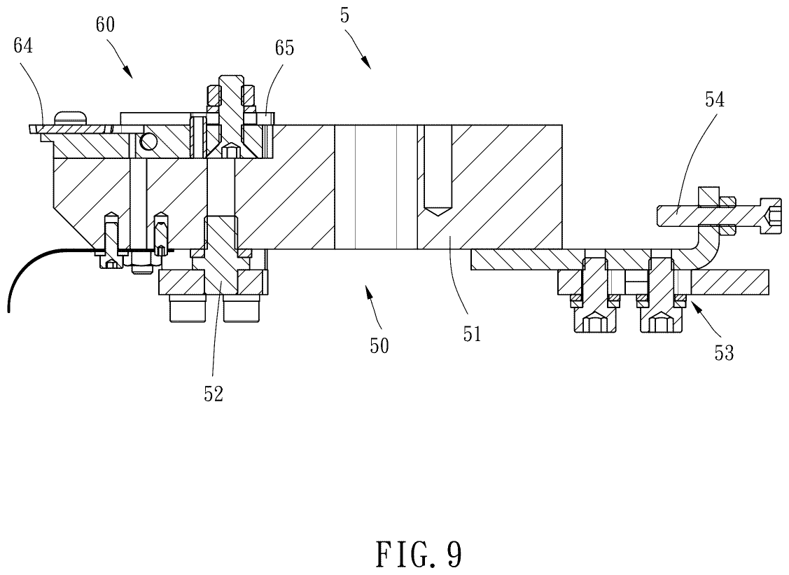

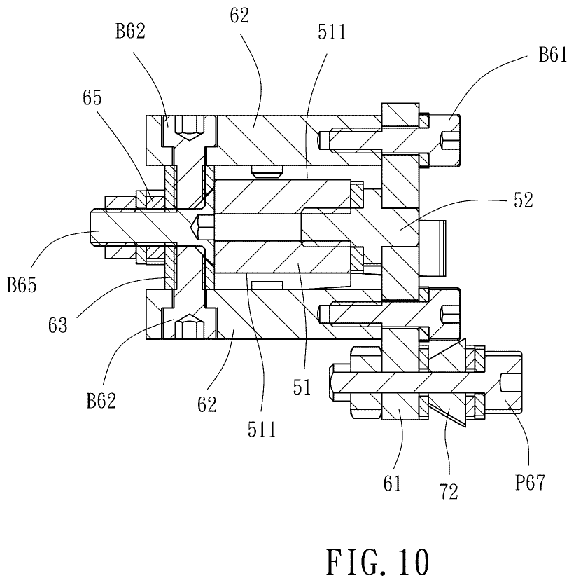

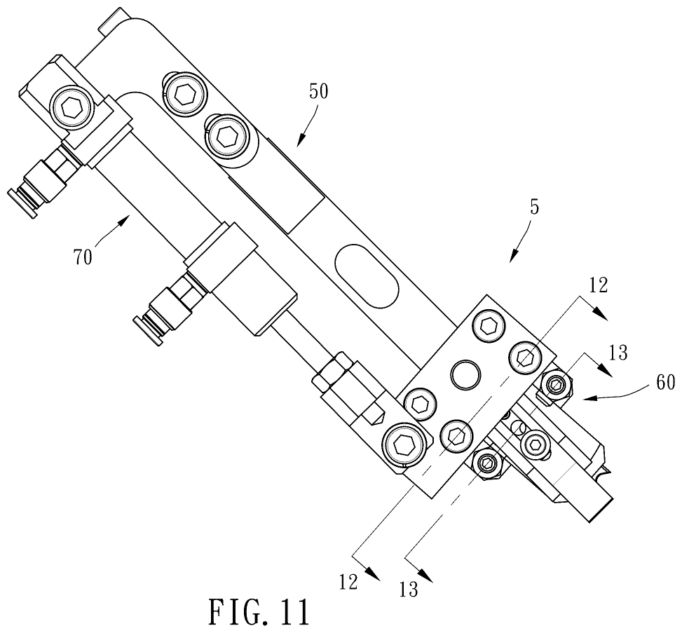

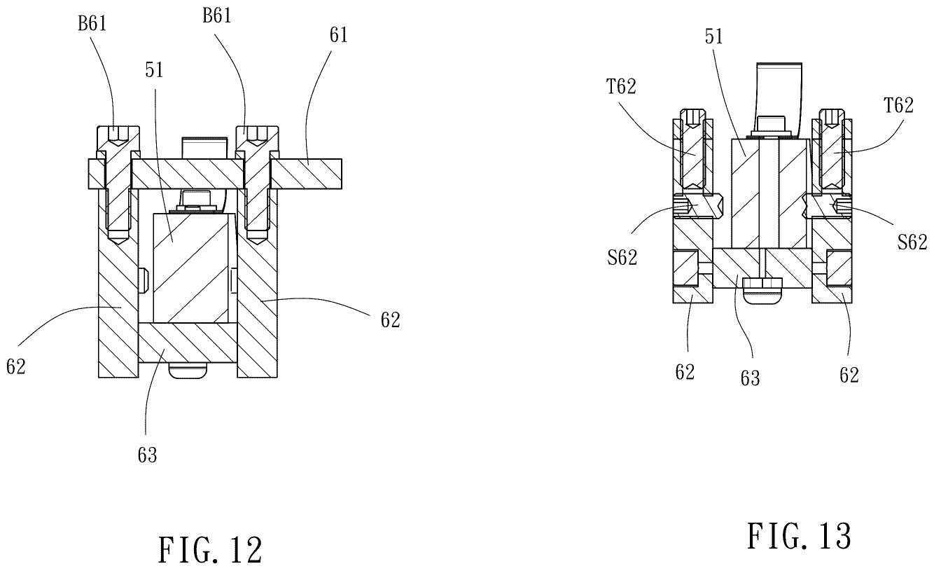

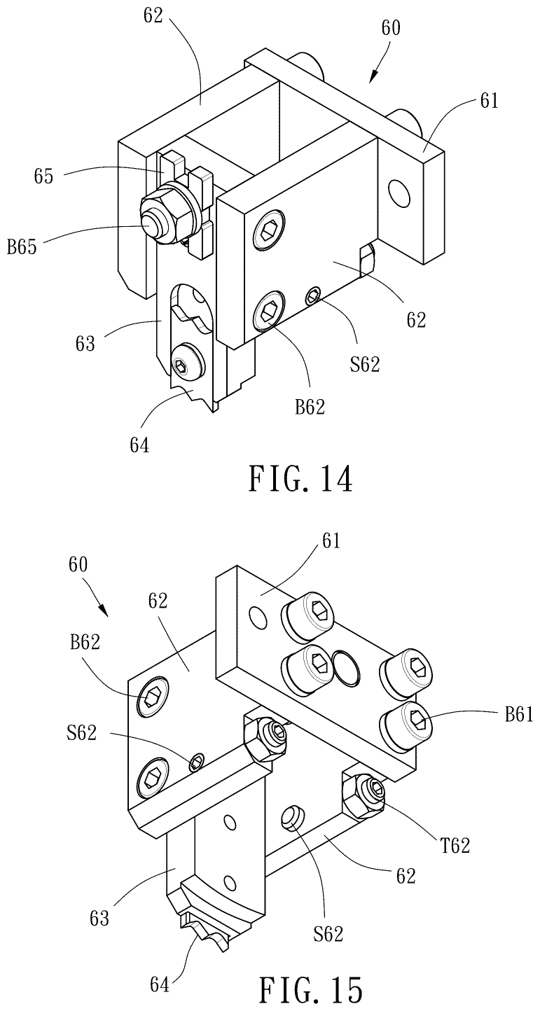

As shown in FIGS. 1-15, a trimming device of the present invention comprises a fixing assembly 10, a mounting assembly 20, a first wheel assembly 30, a second wheel assembly 40, a moving scraper unit 5, and a retractable assembly 70. The trimming device of the present invention is installed in an edge banding machine (not shown) for trimming a to-be-processed workpiece. The to-be-processed workpiece has a top surface and a lateral side with an edge band adhered thereto.

The fixing assembly 10 includes a main body 11, a floating member 12, a plurality of linear bearings 13, an upright pole 14, and a spring 15. The floating member 12 is movable relative to the main body 11 via the linear bearings 13. The upright pole 14 is attached to the main body 11 and penetrated through the floating member 12. The spring 15 is sleeved on the upright pole 14 and abutted against the floating member 12 to urge the floating member 12 downwards.

The mounting assembly 20 is attached to the floating member 12 of the fixing assembly 10 so as to be moved upwards and downwards relative to the fixing assembly 10. The mounting assembly 20 includes a fixing portion 21 connected to the floating member 12 of the fixing assembly 10, a slide groove 22 therein, an elongated hole 221 communicating with the slide groove 22, a forward stop portion 23 located at the rear side thereof, and a backward stop portion 24 located at the front side thereof.

The first wheel assembly 30 is mounted to the mounting assembly 20 and provided with a plurality of first wheels 31 for rolling on the top surface of the to-be-processed workpiece in this embodiment.

The second wheel assembly 40 is mounted to the mounting assembly 20 and provided with a second wheel 41 for rolling on the edge band in this embodiment.

The moving scraper unit 5 comprises a feeding and retracting assembly 50 that includes a slider 51, a first pivot member 52, a connecting member 53, and a forward stop member 54. The slider 51 is slidably disposed in the sliding groove 22 of the mounting assembly 20. A connecting bolt B51 is penetrated through the elongated hole 221 of the mounting assembly 20 and screwed to the slider 51. The first pivot member 52 is connected to the slider 51. The slider 51 has two adjusting edges 511. The retractable connecting member 53 is connected to the slider 51. The forward stop member 54 is abutted against the forward stop portion 23 of the mounting assembly 20 when the moving scraper unit 5 is moved forwards.

The moving scraper unit 5 further comprises a scraper assembly 60 pivotally connected to the first pivot member 52 and sleeved on the slider 51. The scraper assembly 60 includes an upper block 61, two lateral blocks 62, a lower block 63, a scraper 64, a backward stop block 65, two adjusting screws S62, and two lateral screws T62. The upper block 61 is pivotally connected to the first pivot member 52. The lateral blocks 62 are screwed to the upper block 61 by using a plurality of first screws B61 and located at two sides of the slider 51. The lower block 63 is screwed to the two lateral blocks 62 by using a plurality of second screws B62 and located below the slider 51. The scraper 64 is mounted to the lower block 63. The backward stop block 65 is screwed to the lower block 63 by using a third screw B65 abutted against the two second screws B62. The adjusting screws S62 are screwed to the lateral blocks 62 and abutted against the adjusting edges 511 of the feeding and retracting assembly 50, respectively. The lateral screws T62 are screwed to the lateral blocks 62 and abutted against the adjusting screws S62, respectively.

The retractable assembly 70 includes a main body 71 connected to the connecting member 53 of the feeding and retracting assembly 50, and a retractable rod 72 provided in the main body 71 and pivotally connected to the upper block 61 by using a second pivot member P67 for driving the upper block 61. The retractable assembly 70 is, but is not limited to, a pneumatic cylinder.

In accordance with the aforementioned structure, through the forward and backward movement of the slider 51 with respect to a to-be-chamfered position, the distance between the scraper assembly 60 and the to-be-processed workpiece can be rapidly adjusted without the need for complex operational adjustments. Additionally, through the retractable action of the retractable rod 72, the scraper assembly 60 can quickly reach or leave the processing position according to time requirements. In addition, the first pivot member 52 can be used to easily adjust and fix the required angle of the scraper assembly 60. Further, the scraper assembly 60 can be stably adjusted to a desired angle by using the two adjusting screws S62. Furthermore, by blocking the backward stop portion 24 of the mounting assembly 20 with the backward stop block 65, the scraper assembly 60 can be retreated more accurately. the scraper assembly 60 can be retracted more accurately. Therefore, the present invention can achieve the purpose of making the processing and trimming stability of the edge band after edge banding better.

In addition to the above embodiment, the present invention can also be implemented as follows:

For example, the moving scraper unit 5 is not limited to be pivotally connected with the scraper assembly 60 by using the first pivot member 52. The scraper assembly 60 can be directly fixed on the feeding and retracting assembly 50.

Alternatively, the upper block 61, the lateral blocks 62, and the lower block 63 of the scraper assembly 60 are not limited to a three-piece combination. They can also be formed in one piece.

Alternatively, the retractable assembly 70 is not limited to be linked to the scraper assembly 60. The retractable assembly 70 can be changed to be linked to the feeding and retracting assembly 50.

Further, the retractable assembly 70 is not limited to be connected with the scraper assembly 60. The retractable assembly 70 can also be connected with the mounting assembly 20 or other components.

Further, the retractable rod 72 is not limited to be connected with the upper block 61 for driving the scraper assembly 60. The retractable rod 72 can also be connected with the two lateral blocks 62, the lower block 63, other elements of the scraper assembly 60, or other components.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A trimming device of an edge banding machine, comprising:
a fixing assembly;
a mounting assembly attached to the fixing assembly and having a slide groove;
a first wheel assembly mounted to the mounting assembly and having a first wheel for rolling on a top surface of a to-be-processed workpiece;
a second wheel assembly mounted to the mounting assembly and having a second wheel for rolling on an edge band adhered to a lateral side of the to-be-processed workpiece;
a moving scraper unit including a feeding and retracting assembly having a slider slidably disposed to the slide groove of the mounting assembly, and a scraper assembly mounted on the feeding and retracting assembly and having a scraper; and
a retractable assembly having a retractable rod driving the moving scraper unit to move along the slide groove of the mounting assembly.

2. The trimming device of the edge banding machine as claimed in claim 1, wherein the fixing assembly includes a main body, a floating member movable relative to the main body via a plurality of linear bearings, and a spring urging the floating member downwards; the mounting assembly is connected to the floating member.

3. The trimming device of the edge banding machine as claimed in claim 2, wherein the spring is sleeved on an upright pole of the fixing assembly and abutted against the floating member.

4. The trimming device of the edge banding machine as claimed in claim 1, wherein the mounting assembly has a forward stop portion; the moving scraper unit further includes a forward stop member abutted against the forward stop portion of the mounting assembly when the moving scraper unit is moved forwards.

5. The trimming device of the edge banding machine as claimed in claim 1, wherein the mounting assembly has a backward stop portion; the scraper assembly has a backward stop block abutted against the backward stop portion of the mounting assembly when the moving scraper unit is moved backwards.

6. The trimming device of the edge banding machine as claimed in claim 1, wherein the feeding and retracting assembly has a first pivot member pivotally connected to the scraper assembly.

7. The trimming device of the edge banding machine as claimed in claim 6, wherein the feeding and retracting assembly has two adjusting edges; the scraper assembly has two adjusting screws abutted against the adjusting edges of the feeding and retracting assembly, respectively.

8. The trimming device of the edge banding machine as claimed in claim 1, wherein the scraper assembly has an upper block located above the slider, two lateral blocks attached to the upper block and located on two sides of the slider, and a lower block attached to the lateral blocks and located below the slider and mounted to the scraper.

9. The trimming device of the edge banding machine as claimed in claim 1, wherein the retractable assembly is connected to the feeding and retracting assembly for driving the feeding and retracting assembly.

10. The trimming device of the edge banding machine as claimed in claim 1, wherein the retractable assembly is connected to the scraper assembly for driving the scraper assembly.
